(19) United States
(12) Patent Application Publication
(10) Pub. No.: US 2008/0117633 A1
(43) Pub. Date: May 22, 2008

(54) Electrical candle

(75) Inventor: Mike Li, ShenZhen City (CN)

Correspondence Address: KAMRATH & ASSOCIATES P.A., 4825 OLSON MEMORIAL HIGHWAY, SUITE 245, GOLDEN VALLEY, MN, 55422, US

(73) Assignee: BEAUTY ELECTRONICS CO., LTD., Taipei (TW)

(21) Appl. No.: 11/600,651

(22) Filed: Nov. 16, 2006

(51) Int. Cl. F21V 33/00; G10H 7/00

(52) U.S. Cl. 362/253; 84/602

(57) ABSTRACT

An electrical candle has an inner bracket, a minor electrical apparatus, a major electrical apparatus and a connection tube electrically connecting the major electrical apparatus with the minor electrical apparatus. The inner bracket has an open bottom and a top having an opening defined through the top. The minor electrical apparatus connects to the inner bracket and has a base combined with the inner bracket, a lamp bulb protruding from the opening of the top and a simulated snuff covering the lamp bulb. The major electrical apparatus is mounted in the inner bracket and has a main circuit, a media player three decoded circuit to broadcast music and a base. The electrical candle is not dangerous and can emit light like a real candle and broadcast music at the same time. Thus, it is convenient for people.

### BACKGROUND OF THE INVENTION

1. Field of Invention

The present invention relates to an electrical candle, and more particularly to an electrical candle that is candle-shaped, will light by electricity and has a MPEG audio layer three player (MP3 player) to broadcast music.

2. Description of the Related Art

A candle is made of wax and has a snuff. The snuff can be burned to emit candlelight. However, the candle will be burned to generate carbon oxide to pollute environment and produce an odor to make people feel sick. The candle is also dangerous and may cause a fire accident to endanger human lives and possessions. Furthermore, people usually light the candle and turn on an audio or a MPEG audio layer three player (MP3 player) to broadcast music to produce a romantic ambience when they have a meal. If the candle can broadcast music, it will be convenient for people.

To overcome the shortcomings, the present invention provides an electrical candle to mitigate or obviate the aforementioned.

### SUMMARY OF THE INVENTION

The primary objective of the present invention is to provide an electrical candle that is candle-shaped, will light by electricity and has a MPEG audio layer three player (MP3 player) to broadcast music.

To achieve the objective, the electrical candle in accordance with the present invention has an inner bracket, a minor electrical apparatus, a major electrical apparatus and a connection tube. The inner bracket has an open bottom and a top. The top has an opening. The opening is defined through the top. The minor electrical apparatus connects to the inner bracket and has a base, a lamp bulb and a simulated snuff. The base combines with the inner bracket. The lamp bulb protrudes from the opening of the top. The simulated snuff covers the lamp bulb. The major electrical apparatus is mounted in the inner bracket and has a main circuit, a media player three decoded circuit and a base. The media player three decoded circuit electrically connects to the main circuit and can broadcast music when electricity supplied. The base seals the opening bottom and has a switch, a music controller and a universal serial bus port. The switch electrically connects to the main circuit. The music controller electrically connects to the main circuit. The universal serial bus port electrically connects to the main circuit. The connection tube electrically connects the major electrical apparatus with the minor electrical apparatus. The electrical candle is not dangerous and can emit light like a real candle and listen to music at the same time. Thus, it is convenient for people.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view in partial section of an electrical candle in accordance with the present invention;

FIG. 2 is a perspective view of an inner bracket of the electrical candle in FIG. 1;

FIG. 3 is a perspective view in partial section of the electrical candle in FIG. 1 without a barrel;

FIG. 4 is a side view in partial section of the electrical candle in FIG. 1;

FIG. 5 is a perspective view of a minor electrical apparatus of the electrical candle in FIG. 1;

FIG. 6 is a perspective view of a major electrical apparatus of the electrical candle in FIG. 1;

FIG. 7 is a bottom view of the electrical candle in FIG. 1; and

FIG. 8 is a diagram of a major electrical apparatus transmitting signals to a speaker of the electrical candle in FIG. 1.

### DETAILED DESCRIPTION OF THE INVENTION

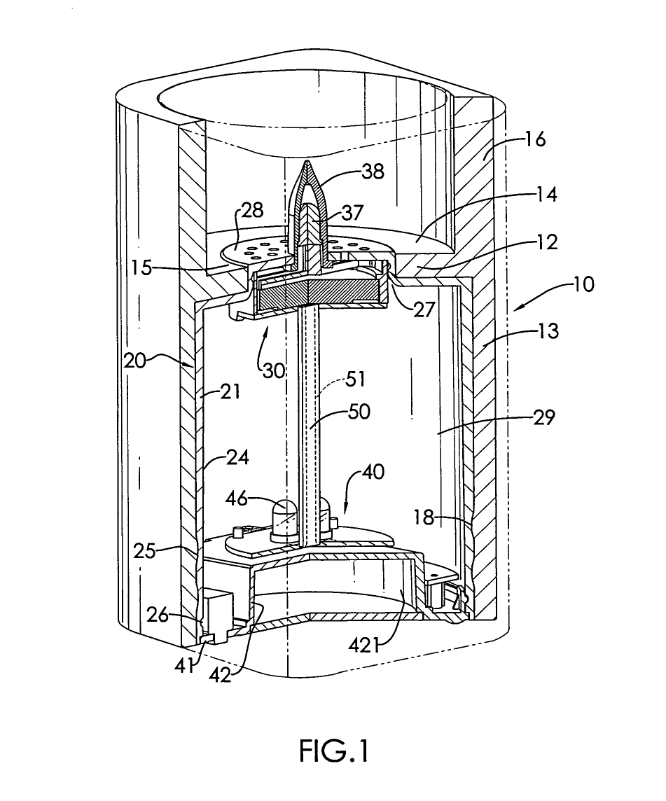

With reference to FIG. 1, an electrical candle in accordance with the present invention has a barrel (10), an inner bracket (20), a minor electrical apparatus (30), a major electrical apparatus (40) and a connection tube (50).

The barrel (10) is hollow, is pervious to light and may be transparent or translucent. The barrel (10) can be made of wax. The barrel (10) has a shape, an inner space (29), an open bottom, a top (12), a sidewall (13) and a barrier (16). The shape of the barrel may be circular, rectangular, polygonal or the like. The sidewall (13) has an inner surface and a first fastener (18). The first fastener (18) is formed on the inner surface of the sidewall (13) and may be at least one annular protrusion or at least one annular groove. The top (12) has an upper surface (14), a lower surface and an opening (15). The opening (15) is defined through the top (12) and communicates with the inner space. The barrier (16) extends upward from the sidewall (13) and is mounted perpendicularly on the upper surface (14) of the top (12).

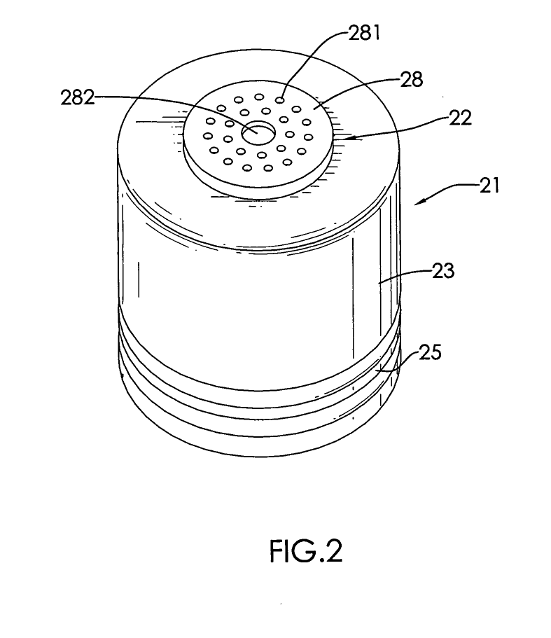

With further reference to FIG. 2, the inner bracket (20) corresponds to the sidewall (13) of the barrel (10) and the opening (15) of the top (12), is mounted in the inner space (29) and the opening (15) of the barrel (10) to blocks the opening (15) of the barrel (10). The inner bracket (20) is pervious to light, is transparent or translucent and may be made of glass or a polymer. The inner bracket (20) has an open bottom, a shell (21) and a cover (22).

The shell (21) is hollow and has an outer surface (23), an inner surface (24) and a top. The outer surface (23) abuts the sidewall (13) and has a second fastener (25). The second fastener (25) corresponds to the first fastener (18), is formed on the outer surface (23), engages with the first fastener (18) to allow the inner bracket (20) to combine with the barrel (10) securely and may be at least one annular groove or at least one annular protrusion. The inner surface (24) has multiple grooves (26). The grooves (26) are formed on the inner surface (24). The top has an opening (27). The opening (27) is defined through the top, communicates with the opening (15) of the barrel (10) and has an annular inside edge.

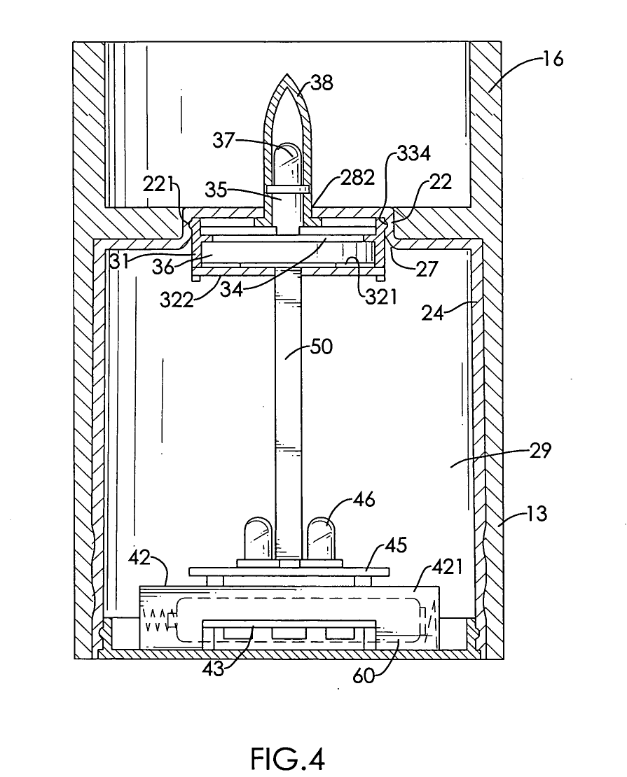

With further reference to FIG. 4, the cover (22) protrudes upward from the annular inside edge of the opening (27) in the shell (21), is mounted in the opening (15) of the barrel (10) and has an open bottom, a sidewall and a closed top (28). The sidewall has an inner surface and an outer surface. The inner surface has multiple grooves (221) defined in the inner surface. The outer surface of the sidewall abuts the barrel (10) and has a bottom edge and a top edge. The bottom edge connects to the annular inside edge of the opening (27). The top (28) is formed on the upper edge of the sidewall and has a central hole (282) and multiple through holes (281) defined through the top (28).

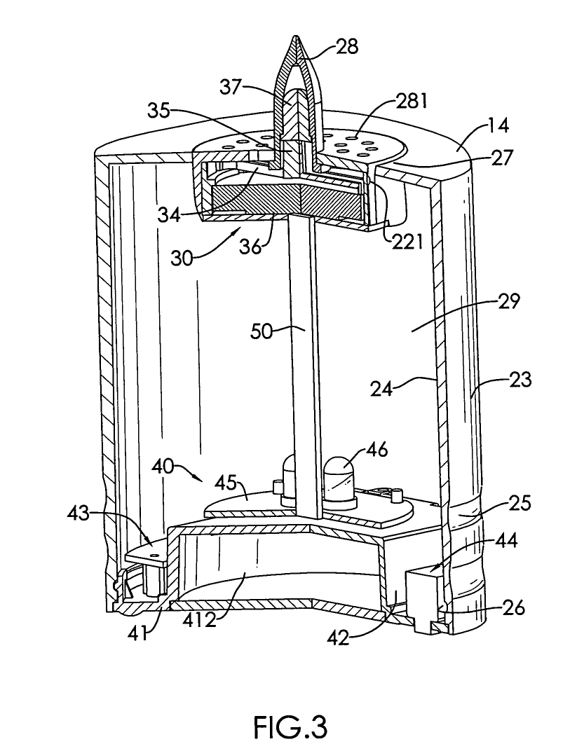

With further reference to FIGS. 3 and 4, the minor electrical apparatus (30) is mounted in the inner bracket (20), may be received in the cover (22) of the inner bracket (20) and has a base (31), a speaker (36), a lamp bulb (37) and a simulated snuff (38).

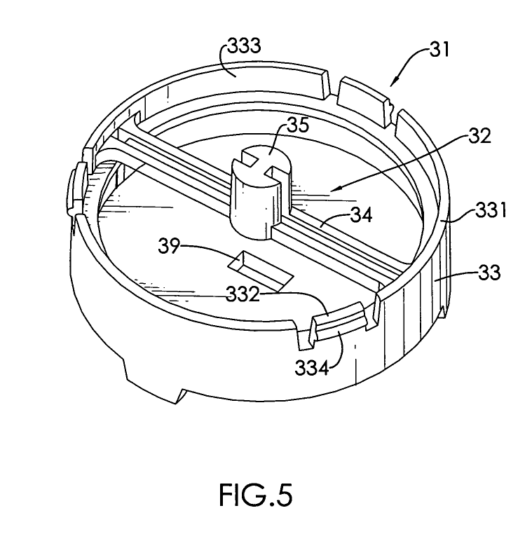

With further reference to FIG. 5, the base (31) is combined with the cover (22) of the inner bracket (20) and has a recess (32), a sidewall (33), a bar (34) and a bulb bracket (35). The recess (32) is formed in the base (31) and has a bottom. The bottom has an upper fastening hole (39). The bottom has an upper surface (321) and a lower surface (322). The sidewall (33) has an annular upper edge (331) and an inner surface (333). The annular upper edge (331) has multiple detents and multiple clips (332). The detents are formed in the annular upper edge (331) and correspond to the grooves (221) in the inner surface of the cover (22). The clips (332) is resilient, are formed respectively in the detents and each clip (332) has an outer surface and a protrusion (334). The protrusion (334) is formed on the outer surface of the clip (332) and protrudes in one of the grooves (221) to allow the cover (20) securely receives the base (31). The bar (34) connects to the inner surface (333) of the base (31), is suspended in the recess (32) and has two ends. The ends are mounted on the inner surface (333) of the base (31). The bulb bracket (35) is mounted on the bar (34), corresponds to the central hole (282) of the inner bracket (20) and protrudes in the central hole (282).

The speaker (36) is mounted in the recess (32), is mounted between the bar (34) and the upper surface (321) of the bottom of the recess (32) and broadcasts music louder from the through holes (281) of the cover (20) when electricity is supplied.

The lamp bulb (37) is mounted securely on the lamp bracket (35) on the base (31) and protrudes from the opening of the top.

The simulated snuff (38) covers the lamp bulb (37).

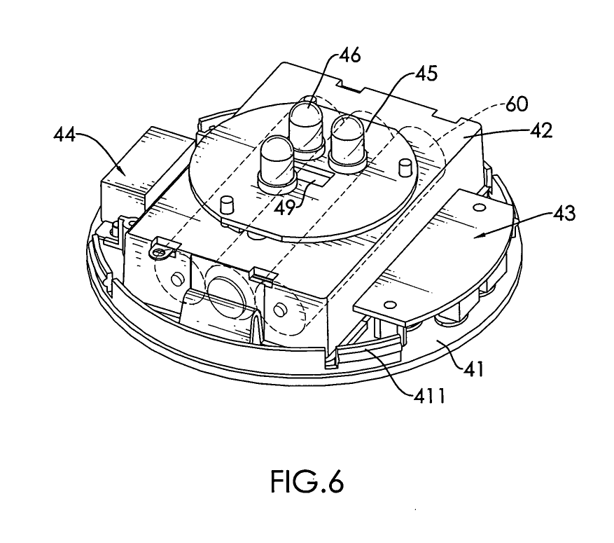

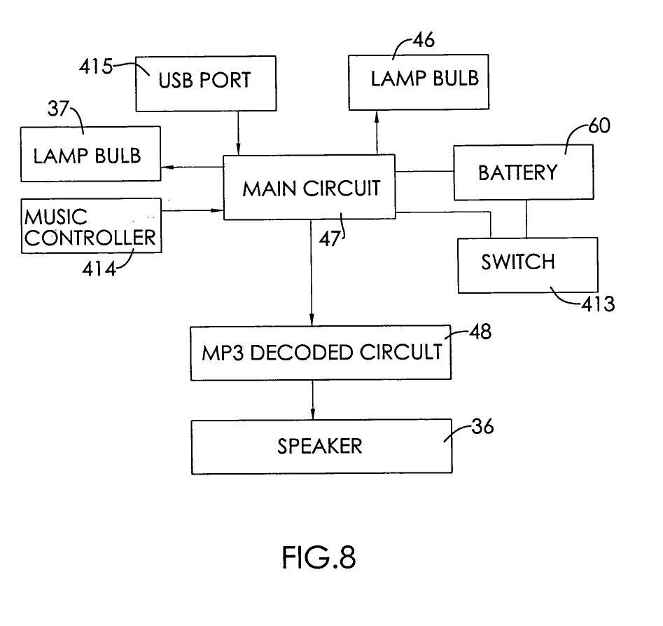

With further reference to FIGS. 6 and 8, the major electrical apparatus (40) is mounted in the inner space (29), seals the open bottom of the inner bracket (20) and has a main circuit (47), a media player three decoded circuit (MP3 decoded circuit) (48), a base (41), a battery box (42), a control assembly, a circuit board (45) and at least one lamp bulb (46).

The main circuit (47) can be controlled by a manual control switch, voice, or vibrations by users.

The MP3 decoded circuit (48) electrically connects to the main circuit (47).

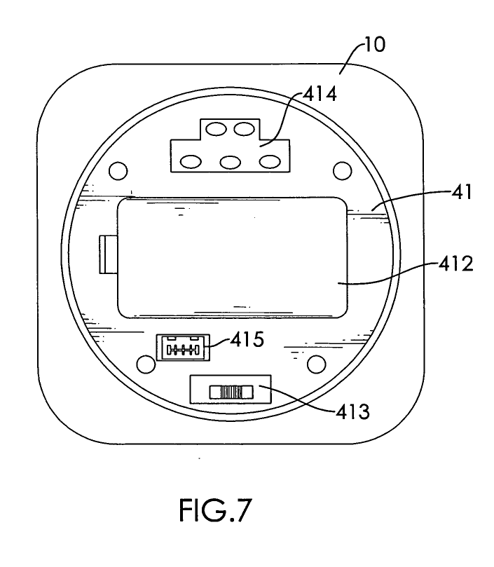

With further reference to FIG. 7, the base (41) seals the open bottom of the inner bracket (20) and has an opening, an upper surface and a lower surface. The opening is defined through the base (41). The upper surface has an annular edge. The annular edge has multiple clips (411). The clips (411) is resilient, corresponds to the grooves (26) in the inner surface (24) of the shell (21) of the inner bracket (20) and each clip (411) has an outer surface and a protrusion. The protrusion is formed on the outer surface and protrudes in the groove (26) in the shell (21) to allow the major electrical apparatus (40) to connect to the inner bracket (20) securely. The lower surface has a detachable cover (412), a switch (413), a music controller (414) and a universal serial bus port (USB port) (415). The cover (412) detachably covers the opening of the base (41). The switch (413) electrically connects to the main circuit (47) and transmit signals to the main circuit (47) to control whether electricity is supplied to the major electrical apparatus (40) and the minor electrical apparatus (20) or not. The music controller (414) electrically connects to the main circuit (47) and transmit signals to the main circuit (47) to control to play, replay, stop, pause music or control other functions. The USB port(415) connects a computer or other electrical appliances with the main circuit (47) by an electrical wire to transmit media player 3 signals (MP3 signals) to the main circuit (47) and then to the MP3 decoded circuit (48). The MP3 signals will be decoded by MP3 decoded circuit (48) to become sound.

The battery box (42) is mounted on the upper surface of the base (41) and has an inner space (421). The inner space (421) communicates with the opening of the base (41) and receives at least one battery (60) to supply electricity to the major electrical apparatus (40) and the minor electrical apparatus (20).

With further reference to FIG. 8, the control assembly electrically connects to the main circuit (47), has two control elements (43, 44) and obtains electricity from the at least one battery (60) to receive signals from the switch (413), the music controller (414) and the USB port (415).

The circuit board (45) is mounted on the battery box (42), electrically connects to the main circuit (47) and has a lower fastening hole (49). The lower fastening hole (49) is formed in the circuit board (45).

Each of the at least one lamp bulb (46) is mounted on the circuit board (45) and is controlled to shined or not to shined by the main circuit (47).

The connection tube (50) electrically connects the major electrical apparatus (40) and the minor electrical apparatus (20) and has an upper end, a lower end and two copper wires (51). The upper end protrudes in the upper fastening hole (39). The lower end protrudes in the lower fastening hole (49). The copper wires (51) connects the MP3 decoded circuit (48) with the speaker (36) to broadcast the sound and with the light bulb (37) to light the light bulb (37).

The electrical candle is not dangerous and can emit light like as a real candle and broadcast music at the same time. Thus, it is convenient for people.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An electrical candle having:
an inner bracket being pervious to light and having
an open bottom;
a shell being hollow and having an outer surface and a top having an opening defined through the top;
a minor electrical apparatus mounted in the inner bracket and having
a base combined with the inner bracket;
a lamp bulb mounted on the base and protruding from the opening of the top; and
a simulated snuff covering the lamp bulb;
a major electrical apparatus mounted in the inner bracket, sealing the open bottom of the inner bracket and having
a main circuit;
a media player three decoded circuit (MP3 decoded circuit) electrically connecting to the main circuit;
a base sealing the open bottom of the inner bracket and having a lower surface having
a switch electrically connecting to the main circuit;
a music controller electrically connecting to the main circuit; and
a universal serial bus port (USBport) electrically connecting to the main circuit and the MP3 decoded circuit; and
a connection tube electrically connecting the major electrical apparatus with the minor electrical apparatus.

2. The electrical candle as claimed in claim 1, wherein the major electrical apparatus further has at least one lamp bulb mounted on the circuit board and electrically connecting to the main circuit.

3. The electrical candle as claimed in claim 1, wherein the inner bracket is made of glass.

4. The electrical candle as claimed in claim 1, wherein the inner bracket is made of a polymer.

5. The electrical candle as claimed in claim 2 further has a barrel being hollow, being pervious to light, receiving the inner bracket and having
an inner space receiving the inner bracket;
a sidewall having
an inner surface; and
a first fastener formed in the inner surface;
a top having
an upper surface;
a lower surface; and
an opening defined through the top and communicating with the inner space of the barrel;
a barrier extending upward from the sidewall and mounted perpendicularly on the upper surface of the top; and wherein:
the shell of the inner bracket further has an outer surface abutting the sidewall and having a second fastener corresponding to the first fastener, formed on the outer surface of the shell and connecting to the first fastener.

6. The electrical candle as claimed in claim 5, wherein
the first fastener of the barrel is at least one annular protrusion; and
the second fastener of the shell of the inner bracket is at least one annular groove.

7. The electrical candle as claimed in claim 5, wherein
the opening in the shell of the inner bracket further has an annular inside edge;
the inner bracket further has
a cover formed upward from the annular inside edge of the opening in the shell, mounted in the opening of the barrel and having
an open bottom;
a sidewall having
an inner surface having multiple grooves; and
an outer surface abutting the barrel and having
a bottom edge connecting to the annular inside edge of the opening; and
an upper edge; and
a closed top formed on the upper edge of the sidewall of the cover and having a central hole;
the minor electrical apparatus is received in the cover of the inner bracket and the base of the minor electrical apparatus is combined with the cover of the inner bracket and has
a recess formed in the base of the minor electrical apparatus and having a sidewall having
a bottom having an upper surface;
an annular upper edge having
multiple detents formed in the annular upper edge and corresponding to the grooves on the inner surface of the cover; and
multiple clips being resilient, formed respectively in the detents and each clip having
an outer surface; and
a protrusion formed on the outer surface of the clip and protruding in one of the grooves in the cover;
an inner surface;
a bar connecting to the inner surface of the base of the minor electrical apparatus, suspended in the recess and having two ends mounted on the inner surface of the base; and
a bulb bracket mounted on the bar, corresponding to the central hole of the inner bracket, protruding in the central hole and on which the lamp bulb is mounted securely.

8. The electrical candle as claimed in claim 5, wherein the barrel is made of wax.

9. The electrical candle as claimed in claim 7, wherein
the closed top of the inner bracket further has multiple through holes;
the minor electrical apparatus further has a speaker mounted in the recess and mounted between the bar and the upper surface of the bottom of the recess.

10. The electrical candle as claimed in claim 7, wherein:
the shell of the inner bracket further has an inner surface having multiple grooves;
the base of the major electrical apparatus further has
an opening defined through the base;
an upper surface having an edge having multiple clips being resilient, corresponding to the grooves in the inner surface of the inner bracket and each clip having
an outer surface; and
a protrusion formed on the outer surface and protruding in one of the grooves in the inner bracket and allowing the major electrical apparatus to connect to the inner bracket securely;
a lower surface having a detachable cover detachably covering the opening of the base of the major electrical apparatus;
a battery box mounted on the upper surface of the base and having an inner space communicating with the opening of the base of the major electrical apparatus;
a circuit board mounted on the battery box, electrically connecting to the main circuit and on which the at least one lamp bulb is mounted.

11. The electrical candle as claimed in claim 10, wherein
the recess has a bottom having an upper fastening hole;
the circuit board of the major electrical apparatus has a lower fastening hole formed in the circuit board;
the connection tube has
an upper end protruding in the upper fastening hole;
a lower end protruding in the lower fastening hole; and
two copper wires connecting the MP3 decoded circuit with the speaker and the light bulb.
